(19) United States
(12) Patent Application Publication
(10) Pub. No.: US 2026/0204604 A1
(43) Pub. Date: Jul. 16, 2026

(54) METHOD FOR DETERMINING A REGENERATION MEASURE IN A FUEL CELL STACK

(71) Applicant: Robert Bosch GmbH, Stuttgart (DE)

(72) Inventors: Jochen Wessner, Esslingen (DE); Christophe Gerling, Filderstadt (DE); Juergen Hackenberg, Sachsenheim (DE); Michael Giuseppe Marino, Linz (AT); Ulrich Berner, Stuttgart (DE); Ulrich Sauter, Karlsruhe (DE)

(21) Appl. No.: 19/134,368

(22) PCT Filed: Dec. 15, 2023
(86) PCT No.: PCT/EP2023/086062

§ 371 Date: May 30, 2025

(30) Foreign Application Priority Data
Dec. 19, 2022 (DE) 10 2022 213 889.9

(51) Int. Cl. H01M 8/04537; B60L 58/30; H01M 8/04303; H01M 8/04664; H01M 8/04701; H01M 8/04746; H01M 8/04828; H01M 8/04858; H01M 8/10

(52) U.S. Cl. CPC H01M 8/04649; B60L 58/30; H01M 8/04303; H01M 8/04679; H01M 8/04701; H01M 8/04753; H01M 8/04828; H01M 8/0491; H01M 2008/1095; H01M 2250/20

(57) ABSTRACT

The invention relates to a method (200) for determining a regeneration measure in a fuel cell stack (10) of a fuel cell assembly, preferably of a fuel cell vehicle, wherein, at least at a portion (100) of the fuel cell stack (10), an electric high-frequency resistance is determined, and a high-frequency resistance quality of the fuel cell stack is determined therefrom, wherein at least one regeneration measure in the fuel cell stack (10) is determined using this high-frequency resistance quality, and/or a time window for a/the regeneration measure in the fuel cell stack (10) is determined.

### BACKGROUND

The invention relates to a method for determining a regeneration measure in a fuel cell stack of a fuel cell assembly. Furthermore, the invention relates to a method for carrying out a regeneration of a fuel cell stack of a fuel cell assembly. Furthermore, the invention relates to a fuel cell assembly, a fuel cell system, and a fuel cell vehicle.

In a low-temperature polymer electrolyte fuel cell of a fuel cell unit (stationary or mobile), e.g., of a fuel cell system e.g., of a fuel cell vehicle, an electrochemical conversion of two reactants of two operating media into electrical energy and heat takes place. The fuel cell in this case comprises at least one membrane electrode assembly (MEA). As a rule, the fuel cell is designed to comprise a plurality of membrane electrode assemblies arranged in a stack and bipolar plates arranged between them (fuel cell stack or stack having a plurality of individual fuel cells).

### SUMMARY

Fuel cell stacks need to be regenerated from time to time in order to minimize i.e., reduce, compensate, prevent, etc. a degradation, i.e., an already existing, a continuing, an emerging, an anticipated, etc. deterioration of the fuel cell stack itself and/or a media state in the fuel cell stack. Such a deterioration relates to, for example, an integrity, a water content, a performance, a hydrogen consumption, etc. of the fuel cell stack. A degradation can be, for example, a substantially completely reversible, a conditionally reversible, or a substantially irreversible degradation of the fuel cell stack, or only of a portion thereof.

In particular, a degradation relates to at least one, a plurality, a large number, or substantially all of the membrane electrode units of the fuel cell stack, or a portion (e.g., only a cathode or an anode) thereof, respectively. Of course, other parts, regions, or portions, such as one, a plurality, a large number, or substantially all of the bipolar plates, can also be affected by the degradation. The degradation of the fuel cell stack is reduced by a countermeasure, i.e., a regeneration measure (regeneration method, recovery). A problem addressed by the invention is to specify a method for determining a regeneration measure in a fuel cell stack of a fuel cell assembly.

The problem addressed by the invention is solved by a method for determining a regeneration measure in a fuel cell stack of a fuel cell assembly, by a method for carrying out a regeneration of a fuel cell stack of a fuel cell assembly, as well as by means of a fuel cell assembly, a fuel cell system, or a fuel cell vehicle. Advantageous further developments, additional features and/or advantages of the invention are apparent from the dependent claims and the following description.

In the method according to the invention for determining a regeneration measure, at least at a portion of the fuel cell stack, an electric high-frequency resistance is determined, and a high-frequency resistance quality of the fuel cell stack is determined therefrom, wherein at least one arbitrary or necessary regeneration measure in the fuel cell stack is determined using this high-frequency resistance quality, and/or a time window for a/the regeneration measure in the fuel cell stack is determined.

In principle, the high-frequency resistance can be measured (preferably), detected, sensed, diagnosed (AI: artificial intelligence) and/or determined by a model (physical, AI or hybrid-based); i.e., determined. The same is true for at least one additional parameter inserted below. The portion of the fuel cell stack can comprise a single, a plurality, a large number, or all of the individual cells of the fuel cell stack. The same is true analogously for the at least one other additional parameter of the fuel cell assembly and the fuel cell stack, respectively.

In a first variant, the regeneration measure can be determined based on the high-frequency resistance quality; in a second variant, the regeneration measure can already be predetermined and only one window of time for the predetermined regeneration measure can be determined; and in a third variant, both the regeneration measure and a window of time for the regeneration measure can be determined based on the high-frequency resistance quality.

In order to determine the high-frequency resistance, a high-frequency signal can be superimposed on a DC signal of the fuel cell stack (impedance spectroscopy), wherein the determined high-frequency resistance is evaluated by a generating source and/or by another device. Preferably, the superimposed voltage amplitudes are less than 100 mV, 75 mV, 50 mV, 40 mV, 30 mV, 25 mV, 20 mV, 15 mV, 10 mV, 7.5 mV, 5 mV, 2.5 mV, 2 mV, 1.5 mV, 1 mV or 0.5 mV.

The superimposition of the high-frequency resistance can occur e.g., by means of an inverter and/or a DC/DC converter modulating a high-frequency signal.

The frequencies of the high-frequency signal are in a frequency range of preferably greater than 1kHz; in particular, frequencies of greater than 1.5 kHz, 2 kHz, 2.5 kHz, 5 kHz, 7.5 kHz, 10 kHz, 15 kHz, 20 kHz, 25 kHz, 30 kHz, 40 kHz, 50 kHz or above. The inverter and/or the DC/DC converter can comprise a pulse duration modulation unit for superimposition of the high-frequency signal on a DC supply. Existing DC supply lines from the inverter and/or DC/DC converter can be used for this purpose.

To increase a reliability and/or accuracy, e.g., of a measurement, a frequency of pulse duration modulation can be adjusted to an operating state of the fuel cell stack. A frequency can be selected that is at least twice as large as a frequency of an interference on a current signal (Shannon sampling theorem).

In addition to the high-frequency resistance, at least one additional parameter can be used in order to determine the high-frequency resistance quality. For the determination, the high-frequency resistance and/or the additional parameter can be included into the high-frequency resistance quality as a singular, periodic, discontinuous, or continuous value, as a derivative, and/or as an integral. If the high-frequency resistance and/or the additional parameter is considered a derivative, this can be a first and/or a higher-order derivative. This may be transferable to an integral.

The supplemental parameter can be one of a fuel cell system, a fuel cell assembly, a fuel cell stack, an anode supply, a cathode supply, a moisture exchanger, and/or a coolant supply. An additional parameter can be, for example, an electric voltage, an electric current, an electric current density, a ratio of voltage to current, etc. of the fuel cell stack, in particular the at least one portion of the fuel cell stack. Furthermore, an additional parameter can be a gas pressure, a gas volume flow, a gas humidity, a stoichiometry, a media flow, a mass flow and/or a temperature, etc. on the anode side and/or on the cathode side of the fuel cell stack.

Moreover, it is possible to apply an additional parameter apart from the anode and/or the cathode, e.g., one of an anode supply, a cathode supply, the moisture exchanger, a coolant supply (coolant temperature) etc. of the fuel cell assembly. Furthermore, a value of the high-frequency resistance and/or the additional parameter can be determined based on a triggering by a system variable (e.g., its value). For example, a load requirement on the fuel cell assembly, an output of the fuel cell assembly, etc. can be used.

The determined high-frequency resistance quality of the fuel cell stack can, in a simple case, be determined from at least a single value of the high-frequency resistance. However, preferably a discontinuous or continuous value curve of the high-frequency resistance is used for this purpose. If an additional parameter is used in order to determine the high-frequency resistance quality, this is of course dependent on the high-frequency resistance and the at least one additional parameter. At least a single value of the additional parameter, or preferably a discontinuous or continuous value curve of the additional parameter, can be used for this purpose.

For the determination of the high-frequency resistance quality, a difference formation of two values of the high-frequency resistance and/or the additional parameter can be applied. Thus, the arbitrary or necessary regeneration measure can be determined if at least two or a plurality/large number of consecutive measurements exceed or fall below a difference limit. Of course, trends can also be examined and applied.

For example, due to a comparatively rapidly increasing high-frequency resistance, in particular when a cell voltage of the fuel cell stack is decreasing, it can be inferred that a water content in the fuel cell stack is decreasing. Furthermore, due to a comparatively slowly increasing high-frequency resistance, it can be inferred that an electrode is corroding.

The regeneration measure can be predetermined or determined using the high-frequency resistance quality. Here, the regeneration measure can relate to a degradation of the material fuel cell stack itself and/or a degradation of a media state in the fuel cell stack.

For example, a degradation of the fuel cell stack is characterized in that it is substantially determined by a body portion—e.g., an electrode, a membrane, etc.—of the fuel cell stack. A degradation of a media state of the fuel cell stack is characterized in that it is substantially caused and/or co-determined by at least one current medium—e.g., water in the fuel cell stack, an operating medium, an exhaust medium, etc.—of the fuel cell stack. Such a state can be an operating state, a shutdown state (upon shutdown), an idling state, and/or a start state (upon startup) of the fuel cell assembly.

The regeneration measure can be and/or will be characterized by a type and/or location of the regeneration measure in the fuel cell stack. Here, the regeneration measure is or can be carried out, for example, in at least a portion in the fuel cell stack, in a cathode (deterioration of the cathode electrode, contamination of the cathode, etc.) of the fuel cell stack, in an anode (deterioration of the anode electrode, contamination of the anode, etc.) of the fuel cell stack, and/or at/in membrane electrode units (drying) of the fuel cell stack.

At least one of a temporal start, a time duration, and/or a temporal end can be determined for the time window. Here, the start, duration, and/or end of the time window can be determined from the high-frequency resistance quality of the fuel cell stack. Furthermore, an urgency of the regeneration measure can be considered. For example, in the event of a high urgency, the regeneration measure can be substantially directly initiated or further processed.

Furthermore, in the event of a moderate urgency, the regeneration measure can be initiated or further processed at a suitable opportunity. And, if there is a low urgency, the regeneration measure can be initiated or further processed during a shutdown procedure or during an idling state of the fuel cell assembly.

Initiating the regeneration measure can include initiating another measure, a different method, etc. in the fuel cell assembly and/or in the fuel cell stack (blending, cross-fade). Of course, the initiation of the regeneration measure can also take place even when the other measure is substantially fully discharged or ended.

The regeneration measure can be configured as a rewetting measure of the fuel cell stack, wherein a gas pressure is increased, a gas flow rate is reduced, a gas humidity is increased, a stoichiometry is reduced, and/or a temperature is reduced. Furthermore, additionally or alternatively, an electric flow generated by the fuel cell stack is turned off and on or turned on and off.

Such a rewetting measure can be determined, e.g., by a decreasing cell voltage and an increase in a high-frequency resistance. At least the cell voltage and the high-frequency resistance form the high-frequency resistance quality. For example, the rewetting measure can be initiated if the high-frequency resistance quality is not met.

If an at least sufficiently moist or substantially target-wet state of the fuel cell stack has been achieved, it can be switched back to normal operating conditions of the fuel cell assembly in order to avoid flooding of the fuel cell stack. By means of the high-frequency measurement, a desired water content in the fuel cell stack can, if necessary, be continuously monitored and thus regulated and/or controlled to at least good to substantially optimal operating parameters.

The regeneration measure can be configured as an electrode regeneration measure, wherein an electrode in the anode and/or the cathode of the fuel cell stack is or can be regenerated. Furthermore, the regeneration measure can be configured as a decontamination measure, wherein anode chambers and/or cathode chambers of the fuel cell stack are and/or can be freed from contaminants.

The method according to the invention for carrying out a regeneration is initially initiated by a method according to the invention for determining a regeneration measure and carried out after at least one specification of the method for determining the regeneration measure. The execution of the regeneration of the fuel cell stack can be monitored, wherein in the event of currently unfavorable conditions for regeneration, the execution of the regeneration is discontinued, interrupted, or further carried out with changed parameters. That is to say, the method for carrying out a regeneration may be interrupted several times and may be processed temporarily until completion.

Both methods are feasible and/or carried out by a control unit for the fuel cell stack. The control unit can be configured as a control unit for the fuel cell assembly or a control unit of the fuel cell assembly. Both methods can be or will be carried out online (wireless (computer) network) by an external control routine. Both methods can be or will be carried out during operation, during a shutdown operation, or during an idling of the fuel cell assembly.

Due to the high-frequency resistance quality, a need for regeneration of the fuel cell stack can be easily and reliably detected. For this purpose, a method for regenerating the fuel cell stack with a determination, in particular a measurement, of an electric high-frequency resistance is used in order to improve, for example, a current performance capability and/or a service life of the fuel cell stack.

Thus, the determination, in particular including the measurement of the high-frequency resistance, can be utilized in order to determine a water content in the individual cells of the fuel cell stack (e.g., rewetting measure), a need for regeneration of the fuel cell stack (e.g., electrode regeneration measure), or a need for cleaning an electrode of the fuel cell stack (e.g., decontamination measure, etc.).

### BRIEF DESCRIPTION OF THE DRAWINGS

The invention is explained in further detail hereinafter by way of the attached schematic drawings, which are not to scale, with reference to exemplary embodiments. In the invention, a feature can be positive, i.e., present, or negative, i.e., absent. In the present specification, a negative feature is not explicitly explained as a feature unless it is described as being absent according to the invention. In other words, what is actually achieved—and not an invention construed via the prior art—consists of omitting this feature. The absence of a feature (negative feature) in an exemplary embodiment demonstrates that the feature may be optional (at the discretion of a person skilled in the art). The figures (Fig.) in the drawing, which are merely examples, show:

FIG. 1 a simplified block diagram of an embodiment of a fuel cell unit for a fuel cell system of a fuel cell vehicle, and

FIG. 2 is a possible flowchart of a method according to the invention for determining a regeneration measure as well as for carrying out a regeneration of a fuel cell stack.

### DETAILED DESCRIPTION

The invention is explained in further detail by means of a method 200, 300—see FIG. 2—for determining a regeneration measure (method 200) as well as for carrying out a regeneration (method 300) of a fuel cell stack 10 of a fuel cell assembly 1, in particular for a low-temperature polymer electrolyte fuel cell system of a fuel cell vehicle, i.e., a motor vehicle having a fuel cell or a fuel cell system, respectively. Only those portions of the fuel cell system that are necessary for an understanding of the invention are shown in the drawings.

Although the invention is described and illustrated in more detail by way of preferred embodiments, the invention is not limited by the exemplary embodiments disclosed. Other variations can be derived therefrom without departing from the protective scope of the invention. In particular, the invention can also be based on a different mobile or stationary fuel cell assembly 1 or fuel cell system.

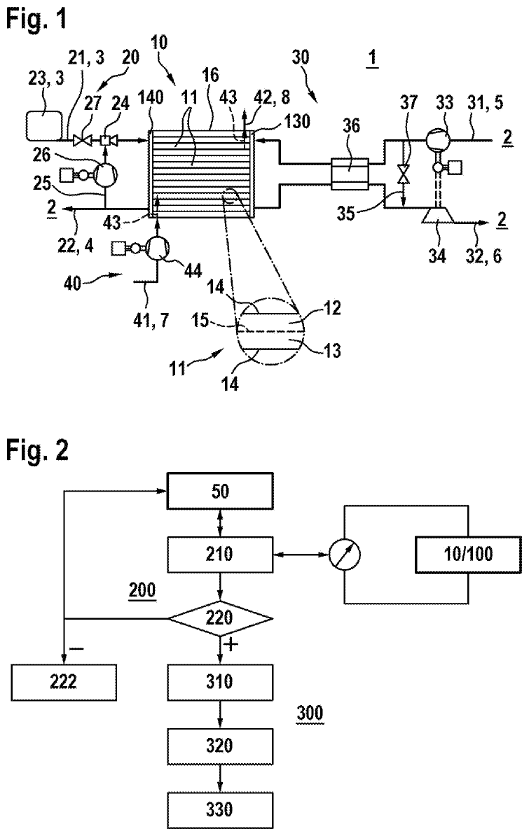

FIG. 1 shows the fuel cell unit 1 according to one embodiment, comprising at least one, in particular a plurality, of single electrochemical fuel cells 11 (single cells 11) bundled together to form a fuel cell stack 10, which are housed in a preferably fluid-tight stack housing 16. Each single cell 11 comprises an electrode chamber 12 designed as an anode chamber 12 and an electrode chamber 13 designed as a cathode chamber 13, which are spatially and electrically separated from each other by a membrane-electrode assembly 15.

Arranged in each case between two directly adjacent membrane-electrode assemblies 15, 15 (including a respective anode chamber 12 and a cathode chamber 13) is a bipolar plate 14, which is used, among other things, to feed/discharge operating media 3, 5 into an anode chamber 12 of a first single cell 11 and a cathode chamber 13 of a second single cell 11 directly adjacent thereto and, in addition, to achieve an electrically conductive connection between these single cells 11, 11.—The cathode chambers 13 and possibly their common inflow region or their electrodes form a cathode 130 and the anode chambers 12 and possibly their common inflow region or their electrodes form an anode 140 of the fuel cell stack 10.

The fuel cell unit 1 comprises an anode supply 20 and a cathode supply 30 for supplying the fuel cell stack 10 with its actual operating media 3 (anode operating medium, actual fuel), 5 (cathode operating medium, usually air).

The anode supply 20 comprises in particular: a fuel reservoir 23 for the anode operating media 3 (flowing in); an anode supply path 21 having a pressure reducer, a shut-off valve, and/or a metering valve 27 (for example) and a jet pump 24 (ejector 24); an anode exhaust path 22 for an anode exhaust gas medium 4 (flowing out, usually into the surroundings 2); preferably a fuel recirculation path 25 with a fluid conveying device 26 located therein, and optionally a water separator and optionally a water container.

The cathode supply 30 comprises in particular: a cathode supply path 31 for the cathode operating medium 5 (flowing in, usually from the surroundings 2), preferably with a fluid conveying device 33; a cathode gas path 32 for a cathode exhaust gas medium 6 (flowing out, usually into the surroundings 2) preferably with a turbine 34, in particular for the fluid conveying device 33; preferably a moisture transfer device 36, in particular a gas-to-gas moistener 36; possibly a cathode-side stack bypass 35 (waste gate 35) between the cathode supply path 31 and the cathode exhaust gas path 22, with a bypass valve 37; and optionally a water separator and optionally a water container.

The fuel cell unit 1 also comprises, in particular, a coolant supply 40 of a thermal system, in particular of the fuel cell vehicle, through which the fuel cell stack 10 can be integrated into a cooling circuit for temperature adjustment in a heat-transferring manner, preferably by means of its bipolar plates 14 (coolant paths 43). The coolant supply 40 comprises a coolant inlet path 41 and a coolant outlet path 42. The coolant 7 (flowing in), 8 (flowing out) circulating in the coolant supply 40 is preferably conveyed by means of at least one coolant conveying device 44.

In addition to the fuel cell assembly 1, the fuel cell system comprises peripheral system components, e.g., a control unit 50 (see FIG. 2), which can be one belonging to the fuel cell vehicle itself.

The method 200, 300 presented here by way of example—FIG. 2—is divided into two sections 200 & 300, each as a method 200 & 300, a method 200 for determining a regeneration measure (regeneration method, recovery), and a method 300 for carrying out a regeneration of a fuel cell stack 10. Here, the method 200 for the determination is situated upstream of the method 300 for carrying out, or the method 200 can abut the method 300.

In the method 200, a measurement 210 of an electric high-frequency resistance is carried out by a control unit 50 on at least a portion 100 (see above) of the fuel cell stack 10, and the high-frequency resistance is determined in this manner. Of course, the high-frequency resistance can also be determined otherwise (see above). From this high-frequency resistance, a high-frequency resistance quality of the fuel cell stack 10 can be determined using an additional parameter (see above). The high-frequency resistance quality is configured so as to reflect a degree of degradation of the fuel cell stack 10, or a portion thereof.

In this case, the high-frequency resistance quality can be configured so as to represent a degradation of the fuel cell stack 10 itself or the portion thereof (see above) and/or a degradation of a media state in the fuel cell stack 10 or the portion thereof (see above) at a correspondingly present degradation. That is to say, at least one arbitrary or necessary regeneration measure can be determined on/in the fuel cell stack 10 by the high-frequency resistance quality.

Furthermore, the high-frequency resistance quality can additionally or alternatively be configured so as to determine a time window (see above) for a regeneration measure in the fuel cell stack 10. The regeneration measure in the fuel cell stack 10 is preferably already pre-determined as an alternative high-frequency resistance quality (see above).

Based on the high-frequency resistance quality, it is determined in a step 220 following step 210 whether or to what extent a regeneration measure is necessary in the fuel cell stack 10. If the method 200 concludes (no: −) in step 220 that no regeneration measure is necessary (step 222), then the method 200 is ended and the method 300 is not initiated at all. In such a case, the high-frequency resistance quality represents a corresponding high quality of the fuel cell stack 10; thus, no regeneration measure is necessary in the short, medium and/or long term.

However, if a regeneration measure is necessary, then the method 300 for carrying out the regeneration is already initiated or can be initiated as a result. That is to say, the method 200 concludes in step 220 (yes: +) that a regeneration measure is necessary. The method is now processed with steps 310, 320, 330. That is to say, a carrying out 310, a monitoring 320, and an ending 330 of the regeneration measure (see above).

The regeneration measure, i.e., carrying out 310 of the regeneration measure, can be configured as a rewetting measure (see above), an electrode regeneration measure (see above), and/or a decontamination measure (see above), etc. In particular when a moisture of the fuel cell stack 10 is determined by the high-frequency resistance quality, this moisture can be continuously or discontinuously monitored, in particular in an operation of the fuel cell assembly 1 (see above).

As part of monitoring 320 of the regeneration measure, carrying out 310 of the regeneration measure can be interrupted. This can be required, for example, due to a current power requirement, a monitoring of the fuel cell stack 10, etc. If better conditions for a regeneration measure are provided in a temporally adjacent manner, this can be resumed.

In particular, it is possible to end the regeneration measure upon shutdown of the fuel cell assembly 1 and to shut down the fuel cell assembly 1 only after the regeneration measure has been ended. Of course, the regeneration measure can also be carried out or brought to an end even when the fuel cell assembly 1 is idling. For this purpose, the fuel cell assembly 1 is ‘awakened’ during an idling state.

In particular, in the case of a time-controlled start of the fuel cell assembly 1, it is possible to perform the regeneration measure before a start of the fuel cell assembly 1 and to complete it when possible. This has the advantage that normal operation of the fuel cell assembly 1 with a freshly regenerated fuel cell stack 10 can occur soon thereafter. Furthermore, no other preparation measures for a start of the fuel cell assembly 1 will then be necessary. The fuel cell stack 10 is already partially or substantially operational.

Temporally after the regeneration measure ends 330, the fuel cell stack 10 can return to an operational state it took prior to the regeneration measure, e.g., to an idling phase. Alternatively, the fuel cell stack 10 can of course assume an operating state characterized by the current requirements for the fuel cell assembly or the fuel cell system, which of course can also be understood as an idling phase.

1. A method (200) for determining a regeneration measure in a fuel cell stack (10) of a fuel cell assembly (1), preferably of a fuel cell vehicle, wherein
at least at a portion (100) of the fuel cell stack (10), an electric high-frequency resistance is determined, and a high-frequency resistance quality of the fuel cell stack (10) is determined therefrom, wherein
at least one regeneration measure in the fuel cell stack (10) is determined using this high-frequency resistance quality, and/or a time window for a/the regeneration measure in the fuel cell stack (10) is determined.

2. The method (200) according to claim 1, wherein, in order to determine the high-frequency resistance, a high-frequency signal is superimposed on a DC signal of the fuel cell stack (10), and the determined high-frequency resistance is evaluated by a generating source and/or by another device.

3. The method (200) according to claim 1, wherein, in addition to the high-frequency resistance, at least one additional parameter is used for determining the high-frequency resistance quality, and/or, for the determination, the high-frequency resistance and/or the additional parameter is included in the high-frequency resistance quality as a singular, periodic, discontinuous, or continuous value, as a derivative, and/or as an integral.

4. The method (200) according to claim 1, wherein the additional parameter is that of a fuel cell system, fuel cell assembly (1), fuel cell stack (10), anode supply (20), cathode supply (30), moisture exchanger (36), and/or coolant supply (40).

5. The method (200) according to claim 1, wherein the regeneration measure is predetermined or determined using the high-frequency resistance quality, wherein
the regeneration measure relates to a degradation of the material fuel cell stack (10) itself and/or a degradation of a media state in the fuel cell stack (10), and/or
the regeneration measure is or will be characterized by a type and/or a location of the regeneration measure in the fuel cell stack (10).

6. The method (200) according to claim 1, wherein at least one temporal start, temporal duration, and/or temporal end is determined for the time window, wherein
the start, duration, and/or end of the time window is determined from the high-frequency resistance quality of the fuel cell stack (10).

7. The method (200) according to claim 1, wherein an urgency of the regeneration measure is considered, wherein the regeneration measure is introduced or further processed:
substantially directly in the event of high urgency, ·at a suitable opportunity that arises in the event of moderate urgency, and/or ·during a shutdown procedure or at an idling state of the fuel cell assembly (1) in the event of low urgency (1).

8. The method (200) according to claim 1, wherein the regeneration measure is configured as a rewetting measure of the fuel cell stack (10), wherein
a gas pressure is increased, a gas volume flow is reduced, a gas humidity is increased, a stoichiometry is reduced, and/or a temperature is reduced, and/or
an electric flow generated by the fuel cell stack (10) is turned off and on or turned on and off.

9. The method (200) according to claim 1, wherein the regeneration measure
is configured as an electrode regeneration measure, wherein an electrode in the anode and/or the cathode of the fuel cell stack (10) is and/or can be regenerated, and/or
is configured as a decontamination measure, wherein anode chambers and/or cathode chambers of the fuel cell stack (10) are and/or can be freed from contaminants.

10. The method (300) for carrying out a regeneration of a fuel cell stack (10) of a fuel cell assembly (1), preferably of a fuel cell vehicle, wherein
the method (300) for carrying out the regeneration of the fuel cell stack (10) is initiated by a method (200) for determining a regeneration measure according to claim 1 and carried out according to at least one specification of the method (200) for determining the regeneration measure.

11. The method (300) according to claim 10, wherein the execution of the regeneration of the fuel cell stack (10) is monitored, wherein
in the event of currently unfavorable conditions for regeneration, the execution of the regeneration is discontinued, interrupted, or further carried out with changed parameters.

12. The method (200, 300) according to claim 1, wherein the method (200, 300) is or can be carried out:
by a control unit (50) for the fuel cell stack (10), ·online by an external control routine online, and/or ·during operation, during a shutdown procedure, or during an idling state of the fuel cell assembly (1).

13. A fuel cell assembly (1), a fuel cell system, or a fuel cell vehicle, wherein,
due to the fuel cell assembly (1), the fuel cell system, or the fuel cell vehicle, a method (200, 300) according to claim 1 is and/or can be carried out.
